(19) United States
(12) Patent Application Publication
(10) Pub. No.: US 2017/0234503 A1
(43) Pub. Date: Aug. 17, 2017

(54) Headlamp Assembly with a Housing and Heat Sink Structure

(71) Applicant: Truck-lite Co., LLC, Falconer, NY (US)

(72) Inventors: Douglas Buffone, Jamestown, NY (US); Alan Felmlee, Russell, PA (US); Nicholas Kenyon, Sherman, NY (US); Mark Halvonik, Panama, NY (US)

(73) Assignee: Truck-lite Co., LLC, Falconer, NY (US)

(21) Appl. No.: 15/583,670

(22) Filed: May 1, 2017

Related U.S. Application Data
(63) Continuation-in-part of application No. 14/475,536, filed on Sep. 2, 2014, now Pat. No. 9,638,388.
Application No. 14/475,536 is a continuation of application No. 13/024,320, filed on Feb. 9, 2011, now Pat. No. 8,845,161.
Application No. 13/024,320 is a continuation-in-part of application No. 14/531,957, filed on Nov. 3, 2014.
Application No. 14/531,957 is a continuation-in-part of application No. 13/024,023, filed on Feb. 9, 2011, now Pat. No. 8,313,177.

(51) Int. Cl. F21S 8/10; B60S 1/02; B60Q 1/00; B60Q 1/04; F21V 29/503; F21V 29/70

(52) U.S. Cl. CPC F21S 48/34; F21S 48/115; F21V 29/503; F21V 29/70; F21S 48/1233; F21S 48/14; F21S 48/31; B60Q 1/0005; B60Q 1/04; B60Q 1/0017; B60S 1/026

(57) ABSTRACT

A headlamp assembly for a vehicle includes housing for coupling the headlamp assembly to a vehicle and a heat sink structure having a first side, a second side, a first edge, and a second edge. A first light emitting diode assembly and a second light emitting diode assembly are each electrically connected to a circuit board. The second edge of the heat sink structure directly contacts an inner surface of the housing, such that the housing is separated into first and second sections by the heat sink structure. Illumination of the first light emitting diode assembly results in a low beam and illumination of both the first light emitting diode assembly and the second light emitting diode assembly results in a high beam.

### BRIEF DESCRIPTION OF THE DRAWINGS

FIG. 1 is a front perspective view of a headlamp assembly with a housing and heat sink structure.

FIG. 2 is a back, perspective view of the headlamp assembly of FIG. 1.

FIG. 3 is a side cross-sectional view of the headlamp assembly.

FIG. 4A is a front perspective view of a lens and FIG. 4B is a side cross-sectional view of a lens.

FIGS. 5A-5D are front, back, side and perspective views of a housing reflector subassembly.

FIGS. 6A-6E are top, bottom, side and back and cross-sectional side views of a heat sink structure.

FIG. 7 is an exploded view of the headlamp assembly.

FIG. 8 front view of an embodiment of a headlamp assembly having a heating element.

FIG. 9 is a front view of a heat sink structure of the headlamp assembly of FIG. 8.

FIG. 10 is a top view of the heat sink structure of FIG. 8.

FIG. 11 is a bottom view of the heat sink structure of the headlamp assembly of FIG. 8.

FIG. 12A is a back assembled view headlamp assembly of FIG. 8.

FIG. 12B is an exploded back view of the headlamp assembly of FIG. 8.

FIG. 13 is a block circuit diagram.

FIGS. 14A-16 are beam pattern illustrations.

### SUMMARY

A headlamp assembly for a vehicle for emitting a high beam and a low beam includes a unitary housing having an inner reflective surface, an exterior surface, an annular rim and a slot formed therein. A heat sink structure having a planar segment and an external heat dissipating segment, with the planar segment having a first side, a second side, and a lens adjacent edge. The planar segment of the heat sink extends through the slot into the unitary housing to separate the housing into first and second segments. The external heat dissipating segment abuts the exterior surface of the housing and includes a plurality of fins formed therein. A first light emitting diode assembly is coupled to the first side of the planar segment of the heat sink structure and a second light emitting diode assembly coupled to the second side of the planar section of the heat sink structure. Further, a lens is fixed to the housing. Heating elements may be attached to and embedded within an inner surface of the lens to eliminate snow and ice. The inner surface may also include a coating to insulate the heating elements.

### DETAILED DESCRIPTION

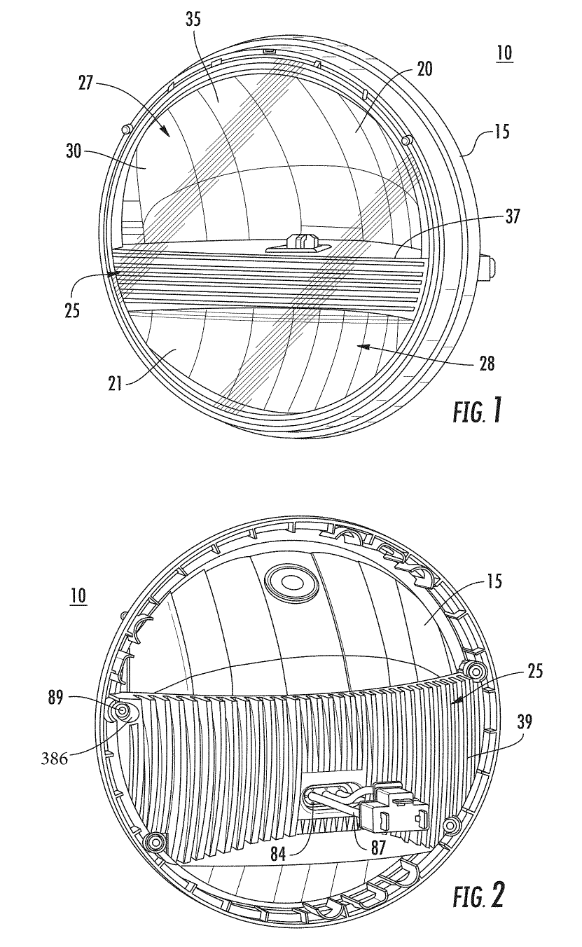

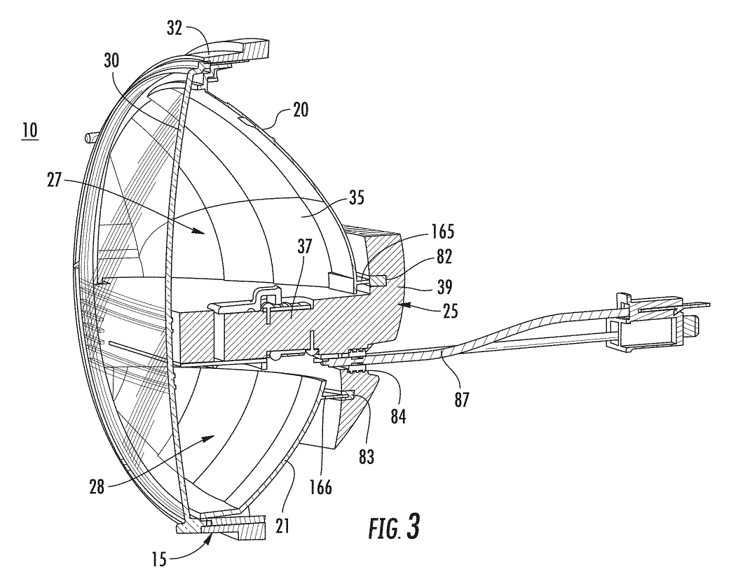

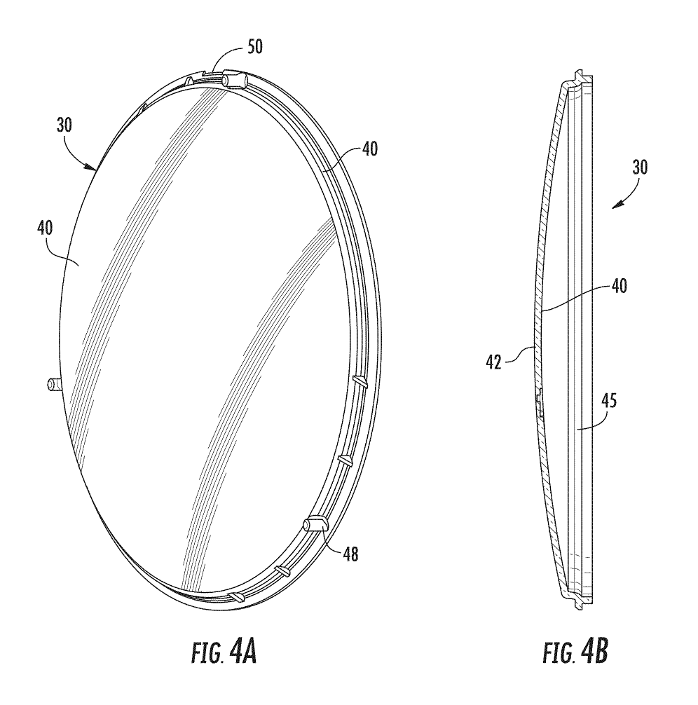

FIGS. 1-3 illustrate front, back, and cross-sectional views of one embodiment of a headlamp assembly 10 for a vehicle. In the illustrated embodiment, headlamp assembly 10 is a 7-in round headlamp with a housing 15 for coupling headlamp assembly 10 to the vehicle. Housing 15 includes a reflective surface forming first and second reflector sections, 20 and 21.

Headlamp assembly 10 also includes a heat sink structure 25, which separates headlamp assembly 10 into first and second areas, 27 and 28. Heat sink structure 25 supports light emitting diode assemblies and a circuit board, as will be discussed in detail below. Headlamp assembly also includes a lens 30 attached to an annular rim 32 of housing 15. Each of first and second reflector sections 20 and 21 includes a plurality of reflector segments or facets, one of which is indicated at 35. A planar segment 37 of heat sink structure 25 extends towards lens 30 and an external heat dissipating segment 39 is positioned adjacent to an exterior surface of housing 15.

Headlamp assembly 10 is adapted to emit both high and low beams. A low beam pattern is emitted when first light emitting diode assembly 65 is illuminated. A high beam pattern is emitted from headlamp assembly when both a first light emitting diode assembly 65 and a second light emitting diode assembly 90 are simultaneously illuminated. A power wire opening 84 for providing a passage for power wires 87 is formed in heat sink structure 25. Further, alignment holes 386 are provided for receiving fasteners 89 for the assembly of the housing 15. Housing 15 also includes a Gore-Tex patch placed within an opening 69 to prevent water from entering headlamp assembly 10 while allowing water vapor to escape.

Rear perspective and side views of lens 30 are shown in FIGS. 4A and 4B. Lens 30 includes an inner surface 40 and an outer surface 42 and is made from an optically clear plastic, such as polycarbonate, and is coated with a hard coat coating such as PHC587 Primerless Hardcoat or UVT200 UV Curable SRC Hardcoat, which protects against degradation from the environment. Optical elements (not shown) may be formed in lens, for example, around the perimeter of lens 30 to diffuse light in the 10 U-90 U glare zone.

In one embodiment, lens 30 is injection molded out of a clear optical grade polycarbonate using a simple open and close tool with normal ejection and a tab gate. The center of the inside of the lens will be inserted in the molded tool design to allow for different logos for private branding. Multiple lens inserts can be created, to allow for quickly interchanging the branded logo in the center of the lens. The lens is permanently fixed to the lamp ensuring a sealed lamp. In particular, lens 30 is vibration welded onto housing 15 such that lens 30 is permanently fixed to housing 15 ensuring a sealed headlamp assembly 10. Vibration welding provides a secure bond between lens 30 and housing 15 and enables a sealed environment for the internal lamp components. Vibration welding also allows lens 30 to be positioned precisely with respect to housing 15. Lens 30 includes ribs 45 on the perimeter of lens 30 which aid in engagement with vibration welding tooling to facilitate the weld operation. Further, lens 30 includes mating features which provide the initial alignment between lens 30 and housing 15. For example, integral pins 48 projecting from a perimeter of lens 30 engage a corresponding hole and slot molded into housing 15. Pins 48 are consumed in the welding process as they liquefy during the assembly process. Additionally there is a notch 50 formed in the perimeter of lens 30 for mating with a tab feature of housing 15. Notch 50 provides alignment and ensures that lens 30 is not placed 180° out of position with respect to housing 15.

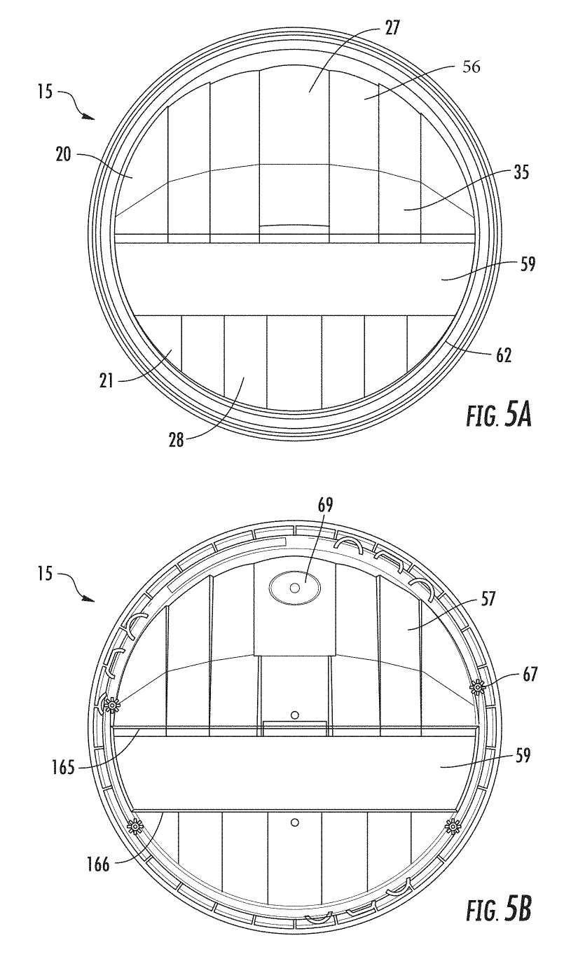

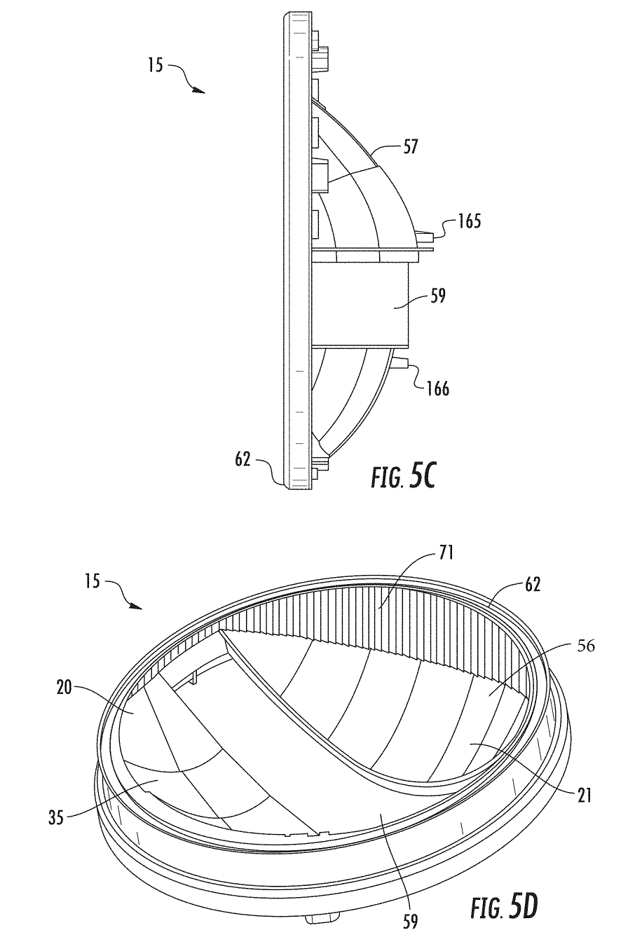

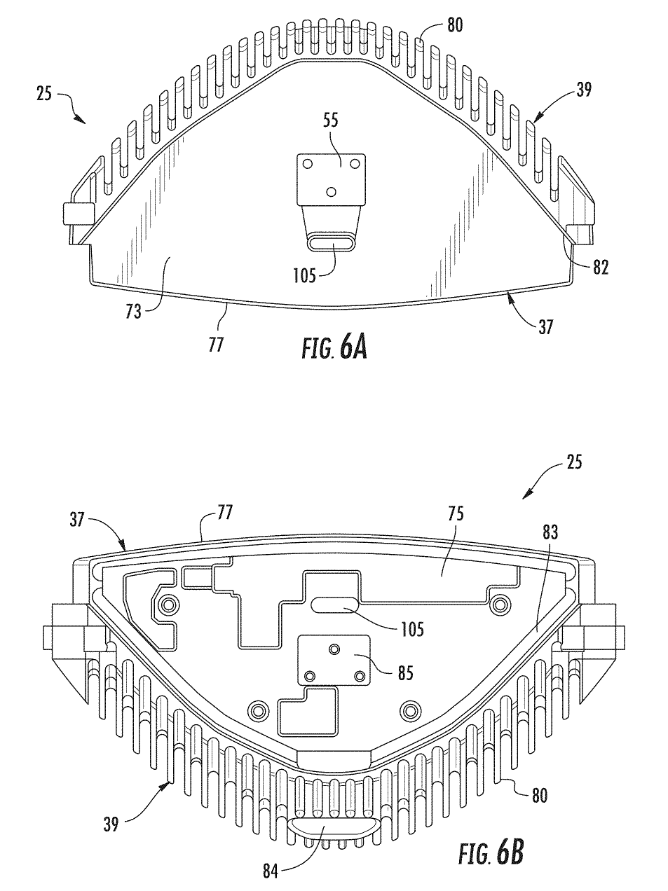

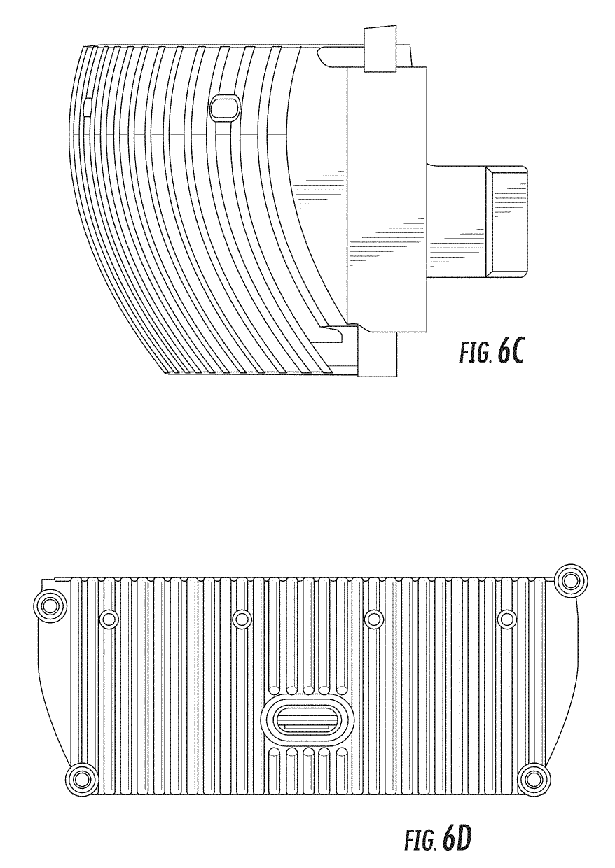

FIGS. 5A-5D illustrate front, back, side and front perspective views of housing 15. In the embodiment shown, housing 15 is a 7-in round housing for coupling headlamp assembly 10 to a vehicle. Housing 15 includes a front side 56 and a back side 57, with an integrated reflector formed in front side 56 and having first and second reflector sections, 20 and 21. In one embodiment, housing 15 is injection molded out of a high flow polycarbonate using an open and close tool with normal ejection and a tab gate. The wall thickness of the housing 15 is approximately 1.65 mm to allow for minimal shrink in the optical area. The reflector optics are aluminum metalized with a physical vapor deposition (PVD) sputtering process. This process combined with the use of the thin wall molded optic and high flow polycarbonate allows for the metalizing process without the use of a base coating, thereby allowing for a more precise facet geometry. The sputtering process provides a very thin coating, which also provides for precise facet geometry.

First reflector section 20 is a low beam reflector and second reflector section 21 is a high beam reflector. Each of first and second reflector sections, 20 and 21, have a complex reflector optic design including multiple intersecting segments or facets, one of which is indicated at 35. The segments intersect at points that may be profound and visible or blended to form a uniform single surface. Facets 35 of first reflector section 20 are asymmetrical from left to right in order to meet the required low beam patterns. Facets 35 of second reflector section 21 are symmetrical to form a high beam reflective pattern is symmetrical left to right. The low and high beam reflector patterns are used in conjunction with each other to produce the required high beam light output function. The asymmetry vertically between the high beam and low beam facets is a balance between several elements. These elements include the light output of the LED's, the required facet surface area to affect a successful pattern and a sufficient mass of the heat sink to dissipate waste heat from the lamp system. Light emitted by the LED's via the reflective surface (facets) is focused to meet the specific photometric performance (pattern and intensity).

The perimeter geometry of housing 15 may match the size requirements of a SAE PAR56, ensuring fit into a mating vehicle bucket geometry, making the lamp interchangeable with all PAR56 applications. Housing 15 is a unitary piece and may be generally bucket-shaped and also includes a center cut out or slot 59 to allow for heat sink structure 25 with the LEDs and drive geometry to be aligned and assembled. Housing 15 has an annular rim 62 on the front for lens 30 to be set on and then vibration welded. At the time of assembly with heat sink structure 25, a silicon adhesive is applied to an upper heat sink gasket groove 82 and a lower heat sink gasket groove 83, formed in a front surface of the heat dissipating segment 39. The rear of the low beam reflector section 20 has a rib 165 that engages upper groove 82 and high beam reflector includes a rib 166 that engages lower groove 83, thereby creating a permanent weather tight seal. The housing has 4 screw bosses, one of which is indicated at 67, which will allow for the heat sink to be mechanically attached. A breathable patch will be placed over a vent hole or opening 69 on back side 57. Front side 56 of housing 15 may also include a texturized surface 71, as shown in FIG. 5D, for scattering or disposing of extraneous or stray light and may exhibit reflective properties if metalized.

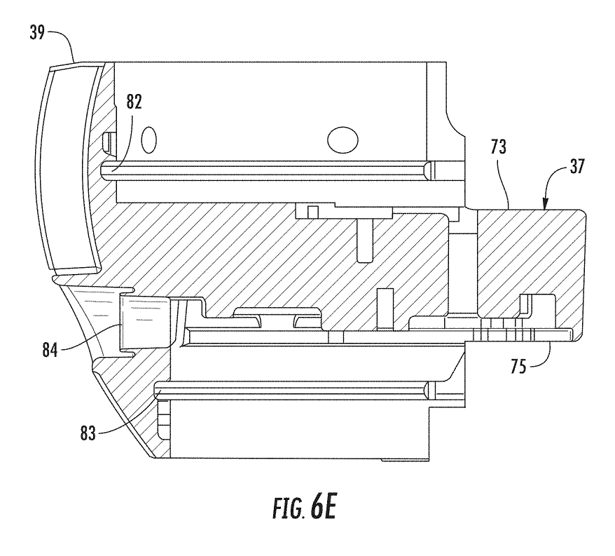

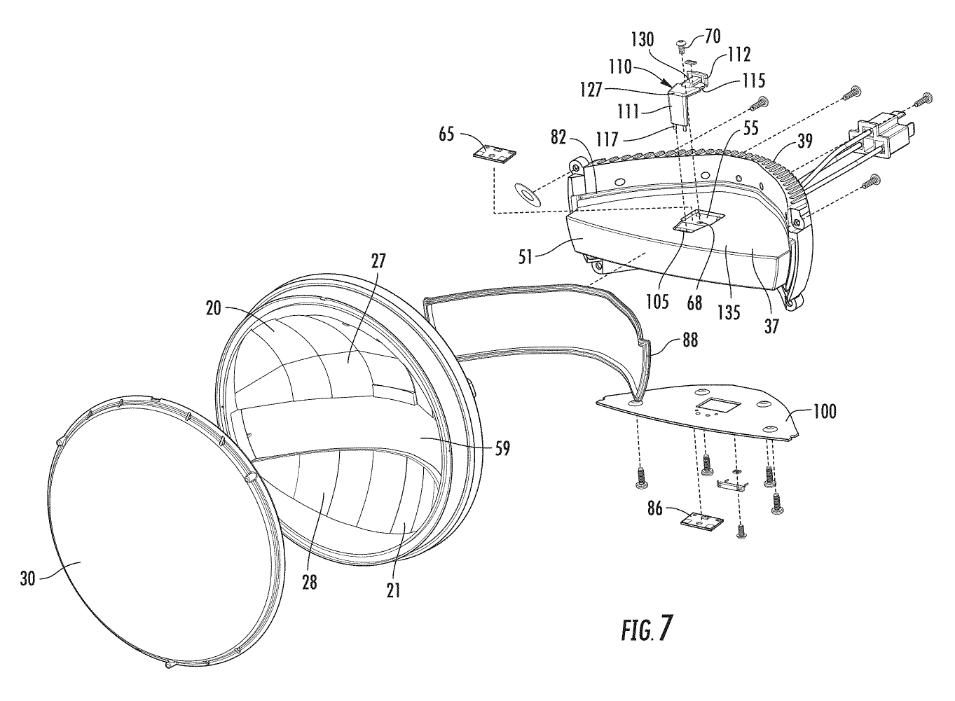

Heat sink structure 25 includes planar segment 37 and external heat dissipating segment 39, as illustrated in FIGS. 6A-6E, which are top, bottom, side, back and cross-sectional view of heat sink structure 25. Planar segment 37 includes a first side 73, a second side 75, and a lens adjacent edge 77. Planar segment 37 extends through slot 59 housing 15 to separate housing 15 into first and second areas 27 and 28. When headlamp assembly 10 is in an assembled configuration, lens adjacent edge 77 is positioned in substantially the same plane as annular rim 62, and external heat dissipating segment 39 is positioned adjacent to back side 57 of housing 15. External heat dissipating segment 39 includes a plurality of fins 80 formed therein. Heat sink structure 25 is optimized to dissipate the largest amount of wattage as possible while using the least amount of material. The material being used for forming heat sink structure 25 is aluminum, such as A360 aluminum alloy as designated by the Aluminum Association. In one embodiment, heat sink structure 25 is made from die cast aluminum through an injection molded process in a tool having slides that retract first to form the geometry around the LEDs and then eject normally in the direction of draw. In general, heat sink structure 25 allows for the alignment and assembly of the LEDs and the driver circuit board within headlamp assembly 10. Upper gasket groove 82, lower gasket groove 83, power wire opening 84 and alignment holes 386 are also included for the assembly of the housing 15.

As illustrated in FIG. 6A, first surface or first side 73 of planar segment 37 includes a first light emitting diode receiving portion 55, which may take the form of an indented area sized to receive a light emitting diode. Alignment posts, not shown, may be formed in first light emitting diode receiving portion 55 for aligning with datum features in a first light emitting diode assembly 65 for accurately aligning light emitting diode assembly 65 on heat sink structure 25. In addition, first light emitting diode receiving portion 55 has holes 68 formed therein for accepting fasteners 70 (see FIG. 7) used for securing a first light emitting diode assembly 65 to heat sink structure 25 in the same plane as first side 73 of planar segment 37. An opening 105 is formed in planar segment 37 of heat sink structure 25 to allow for electrical contact between the LED's and the circuit board, as described in detail below with reference to FIG. 7.

As shown in FIG. 6B, second side 75 of heat sink structure 25 includes a second light emitting diode receiving portion 85 for aligning with a second light emitting diode assembly 90. Second side 75 of heat sink structure 25 is adapted to receive a headlamp circuit board 100 positioned thereon. Although not shown, headlamp circuit board 100 includes electrical components on each side thereof. In one embodiment, a thermal material, such as a GAP pad, is used on a bottom side of headlamp circuit board 100 in order to improve thermal contact between the electrical components and heat sink structure 25. In one embodiment, first light emitting diode assembly 65 is positioned such that the optical axis of the first light emitting diode assembly is perpendicular to the first side 73 of the planar segment 37 of heat sink structure 25 and the second light emitting diode assembly 90 is positioned such that the optical axis of the second light emitting diode assembly 90 is perpendicular to the second side 75 of planar segment 37 of heat sink structure 25.

FIG. 7 is an exploded view of headlamp assembly 10 for illustrating the manner in which headlamp assembly 10 is assembled. When assembled, planar segment 37 of heat sink structure 25 is positioned through slot 59 between first and second reflector sections, 20 and 21, thereby creating first area 27 and second area 28. Planar segment 37 of heat sink structure 25 reduces or prevents light from first area 27 from impinging on second reflector section 21 and reduces or prevents light from second area 28 from impinging on first reflector section 20. Gasket 88 is positioned within gasket groove 82 and between housing 15 and heat sink structure 25. External heat dissipating segment 39 of heat sink structure 25 is positioned adjacent to or against a back surface of housing 15. Heat sink structure 25 also includes a substantially straight or first edge 51, which is positioned near lens 30 in headlamp assembly 10.

A combined buss bar and light blinder assembly 110 including a buss bar portion 111 and a light blinder portion 112 is also attached to heat sink structure 25. Buss bar portion 111 includes thermal stampings that contact first light emitting diode assembly 65 at a first ends 115 and extend through an opening 105 formed in heat sink structure 25 to contact headlamp circuit board 100 at second ends 117. An overmold 127 is positioned over the thermal stampings to insulate thermal stampings from heat sink structure 25, which is formed of a conductive material. Overmold 127 may be formed of a material suitable for high temperature applications, such as a glass filled nylon material. First ends 115 and second ends 117 are left uncovered to provide the necessary electrical contacts. In one embodiment, the thermal stampings are made of tin plated brass. Alternatively, a ribbon cable, buss bar, or other suitable device may be used to make an electrical connection. Light blinder portion 112 may be connected to overmold 127 with an integral extension 130.

Light blinder assembly 110 is positioned on the first side 73 of planar segment 37 of the heat sink structure for blocking a section of light from the first light emitting diode assembly 65. In one embodiment, light blinder portion 112 blocks light from a glare zone in a photometric pattern. Light blinder portion 112 may include bottom projections (not shown) for contacting first light emitting diode assembly 65. Therefore, light blinder portion 112 is positioned perpendicular to first light emitting diode assembly 65 such that light emitted in the 10 U to 90 U range is shielded.

An additional embodiment of a headlamp assembly is generally indicated at 210 in FIGS. 8-12B. Headlamp assembly 210 includes a lens 230 having a resistive wire heating element 216 embedded therein, a housing 215 and a heat sink structure 225.

Wire heating element 216 is embedded in lens 230 via ultrasonic technology, which may be performed through robotics to easily accommodate variations in lens surface, variables in wire patterns, and for improved accuracy and speed. Wire heating element 216 may also be attached to non-embeddable materials using ultrasonic technology with the use of coated wire wherein the coating material is melted ultrasonically, thereby becoming an adhesive between wire heating element 216 and the non-embeddable material. Resistive wire heating element 216 may be a copper core with a silver coating to prevent corrosion of wire heating element 216. Typically resistive wire heating element 216 is embedded in lens 230 at a depth approximately ⅔ of the full wire diameter (⅔ d). In one embodiment, the diameter of resistive wire heating element 216 is approximately 3.5/1000 inches so the embedding depth is between 0.06-0.09 mm. The wire is embedded by tapping it into the lens at a frequency which locally excites the lens molecules causing the lens to melt locally to the wire. Force control is used to prevent pushing the wire down farther than desired so that the embedding head does not directly impact the lens.

An encapsulating material may be used to cover wire heating element 216 on an inside surface of lens 230 to prevent localized superheating (i.e. fusing) of wire heating element 216 due to exposure to air. When wire heating element 216 is exposed directly to the air the heat generated in wire heating element 216 cannot transfer fast enough to the air through convection. Thus, the temperature of wire heating element 216 exceeds the melt temperature of wire heating element 216. The encapsulating material prevents overheating by accepting heat transfer through conduction on the order of 1000 faster than convection to the air. Thus, the temperature of wire heating element 216 is not raised enough to melt the wire, the lens, or the encapsulating material(s). A suitable encapsulating material is an organosilicon compound such as a Hexamethyldisiloxane (HMDSO) is coating. Other encapsulating materials that are Department of Transportation compliant, as specified for optical grade materials/coatings, must have adequate adhesion to the lens material, must have temperature limitations not less than that of the lens material or the heater wire maximum temperature under prescribed conditions, and must not violate other design features/parameters. The encapsulating material also helps to prevent wire heating element 216 from coming free from lens 230 due to random vibration or impact.

A coating or encapsulating material may also be applied on an outside surface of lens 230 to protect lens 230 against environmental deterioration from weather (UV rays, heat, cold, rain, snow, and ice). It also resists damage from sand and dirt. Coatings or encapsulating materials are used on polycarbonate headlamp lenses to meet FMVSS 108 abrasion test requirements and chemical resistance (ASTM Fuel Reference C, Tar Remover, Power Steering Fluid, Antifreeze, and windshield washer fluid). For example, the coatings may be hard coat materials that aid against environmental deterioration, such as PHC587 Primerless Hardcoat or UVT200 UV Curable Hardcoat.

Wire heating element 216 is actively controlled in order to increase performance and efficiency of the wire heating element 216. A heating element circuit board 240 is operably connected to the headlamp circuit board 100 such that wire heating element 216 may be used in various lamp designs.

Heating element circuit board 240 may include a thermistor, shown at a terminal end of wire heating element 216, on the outward facing side for heater control feedback purposes. In some embodiments, heating element circuit board 240 and thermistor are positioned within a pocket or cavity within the inner surface of the lens or embedded into lens 230 such that the distance between an outer surface the thermistor and an outer surface of the lens does not exceed 1/10 the distance from the outer surface of thermistor and an inner surface of the lens at any one point for the purpose of minimizing the thermal impedance between the thermistor and outer lens surface and maximizing the thermal impedance between the thermistor and the inner lens surface. Thermal impedance is therefore manipulated by varying the thermistor's distance from the inner and outer surfaces of the lens, represented by the equation: Do≦( 1/10) Di where Do=the distance from the thermistor to the outer lens surface and Di=the distance between the thermistor and inner lens surface. Therefore, the resistance to heat transfer is at least 10 times more from the thermistor to the inside air compared to the resistance to heat transfer between the thermistor and the outside of the lens.

Thermal compression bonding or welding is utilized to attach heating element circuit board 240 to lens 230. Heating element circuit board 240 may be affixed to lens 230 using a two component, 1:1 mix ratio epoxy from Star Technology (Versabond ER1006LV). Alternate adhesives may be used based on temperature range, adhesive strength/durability, out-gassing properties, chemical reactivity, flexibility, application method, cure time, appearance, availability, and cost. Acceptable adhesives include non-cyanoacrylate based adhesives.

The resistance of the thermistor may be used to accurately predict the outer lens surface temperature wherein the ratio of distances versus the desired accuracy of the control system feedback is calculated and validated empirically. Thermal impedance is the resistance to transfer heat from any one point to any other point (if the thermal impedance is high, less heat transfer will occur and vice versa). The thermistor needs to be sensitive to temperature changes on the lens surface because that is the surface from which water-based contamination such as snow and ice is removed. Therefore, it is necessary to have very low thermal impedance from the thermistor to the outer lens surface. In this case, the lens material and outer lens coating are the thermal barriers between the thermistor and the outer lens. In addition, it is important to maximize the resistance from the thermistor to the inside of the lamp so the inside lamp temperature does not affect the temperature reading sensed by the thermistor.

The thermistor may be a surface mount resistor that is comprised mainly of alumina. The thermistor operates under a programmable logic sequence in order for wire heating element 216 to be activated and deactivated automatically in order to melt snow and ice on the lens. The thermistor is used to provide feedback to the micro-controller in the form of a resistance. This resistance is correlated to a temperature that the micro-controller stores and uses to decide whether the heater should be on or off and at what level of power. The resistance/conductivity of wire heating element 216, as well as that of the actual thermistor and heating element circuit board 240, is factored-in to optimize the operation of the thermistor. In one embodiment, wire heating element 216 is adapted to activate at 10 degrees Celsius and deactivate at 15 degrees Celsius. However, the micro-controller may also be programmed to activate or deactivate wire heating element 216 based on a resistance that is stored in the microcontroller from current and voltage that is associated with a specific temperature. In particular, the thermistor is for sensing the thermal impedance of the lens material and the outer lens coating from the thermistor to the outer surface of the lens allowing the thermistor to be sensitive to temperature changes of the outer surface of the lens, and for maximizing the resistance from the thermistor (1150) to the inside of the lamp, as the inside temperature of the housing does not affect the temperature reading sensed by the thermistor.

The area of the lens to be heated is first determined by considering the area(s) of the lens that light passes through for the lamp function(s) that will be active (or desired) when lens heating is necessary. From this data, the required heater power is determined using ambient temperature set to the lowest defined operating temperature of the lamp, an assumed water based contamination layer on the lens exterior (approximately 2 mm thick), lens material and thickness, and required wire spacing (assuming uniform and non-segmented heating is desired). Other considerations include lamp internal air temperature prediction based on the previously listed parameters and heat dissipation from active lamp functions (CFD used for this), time desired/required to remove the water based contamination, assumed air convection coefficient inside and outside of the lamp, latent heat of fusion of ice, density of ice, and heat capacity of all material in the heat transfer paths (including the ice). This information is used to mathematically express heat transfer from the wire to the air (both inside and outside of the lamp) and the amount of energy to raise the temperature of the ice to zero degrees C. and convert the ice to water as a function of time. The mathematical expressions are combined and solved to determine the amount of power required from the heater wire to melt the ice in the desired/required time period so that once the ice is melted, the water runs off the lens due to gravity.

When multiple operating voltages are required, multiple heating element circuits are used and configured in series, parallel, or a combination of series and parallel in order to attain uniform heater power at any of the prescribed input voltages for a linear type heater driver. Alternately, a switcher type driver may be used with a single heater circuit. The inherent resistance of the control system components including the thermistor in the lens must be offset in one of the heating element circuits for systems with multiple heating element circuits to ensure uniform heating between circuits (unless otherwise desired), because that resistance adds to the heating element circuit, therein reducing the amount of current that flows through it compared to other circuits. This is readily achieved by modifying the length of each circuit such that the resistances balance when the control system net resistance is added to one circuit. Straight paths of the heater circuit as embedded into the lens are minimized to reduce the appearance of light infringement within the optical pattern in order to produce a clearer more vivid shape that is more easily perceived by the human eye. Additionally, the embedding process creates a meniscus of lens material along the heater wire. The shape of this meniscus bends light around the wire such that, for a curved path, light bent away from the wire which leaves a void at angle A, will be bent toward a void at angle B, thus reducing the clarity or even eliminating such void.

It will be understood by those skilled in the art that the above disclosure is not limited to the embodiments discussed herein and that other methods of controlling heating element, thermal transfer fluid circulating device, or Peltier heat pump may be utilized. These methods may include manual activation and deactivation of heating element, thermal transfer fluid circulating device, or Peltier device via an on/off switch. Other alternative embodiments include continuous activation of the elements so that LED lamp temperature is high enough to prevent accumulation of water-based contamination but low enough to prevent inadvertent thermal deterioration of the LED lamp and its components.

In particular, the heater control is a closed loop controller comprised of a programmable micro controller (already existing in headlamp main PCB), the lens thermistor, a current sensing resistor, a voltage sensor, a MOFSET, and the heater wire circuit. The micro-controller monitors the outer lens temperature by calculating the lens thermistor's resistance at regular clock intervals, which has a known correlation to temperature. When the temperature is determined to be at or below a set activation temperature (programmed into the micro-controller), the micro-controller provides a signal to the MOFSET which connects one leg of the heater circuit to lamp power (the other leg is connected to ground), therein powering the heater. If the temperature is determined to be above a set deactivation temperature (also programmed into the micro-controller), it provides a signal to the MOFSET to disconnect the leg of the heater circuit from power, therein removing any power in the heater circuit. The micro-controller can also modulate power for the purpose of power regulation. Further, the microcontroller calculates heater wire temperature and will regulate heater power to prevent the heater wire from exceeding the melt or softening temperature of the lens material as needed.

Heating element circuit board 240 contains conductive pads to facilitate heater circuit leads in consideration of the circuit configuration plus two thermistor control leads. The conductive pads may be formed of copper covered nickel coated with gold to provide a non-corroding, malleable surface that is conducive to welding or thermal compression bonding of wire heating element 216, as well as additional electrical attachment via spring containing (pogo) pins. In general, thermal compression bonding includes applying high temperature and pressure (locally) to mechanically fuse two materials together. Typically, a hard material is superimposed onto the end of a pressing mechanism capable of high pressure with a heating element used to heat the hard material. The two materials desired to be bonded together are pressed together with substantial force while the hard material on the end of the press is heated causing the two materials to bond together at the molecular level. The process can be used to bond similar materials (metal to metal) or dissimilar materials (metal to ceramic) together effectively.

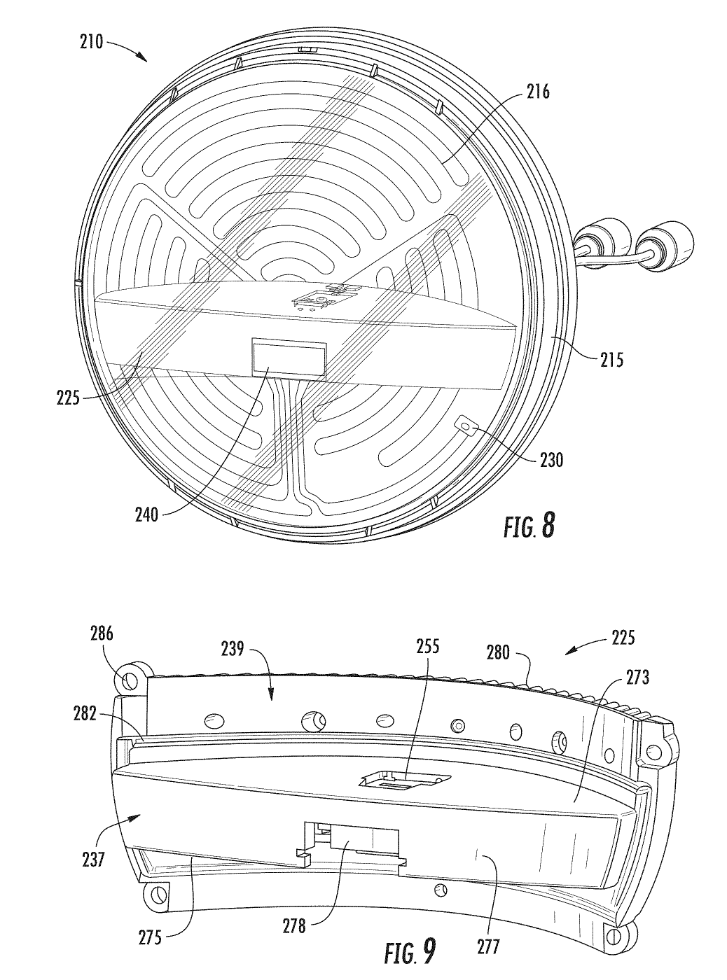

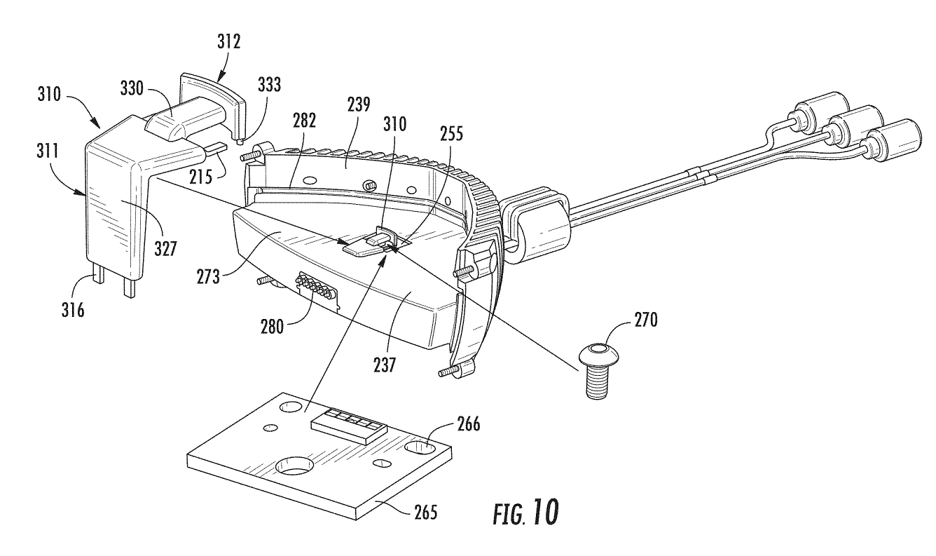

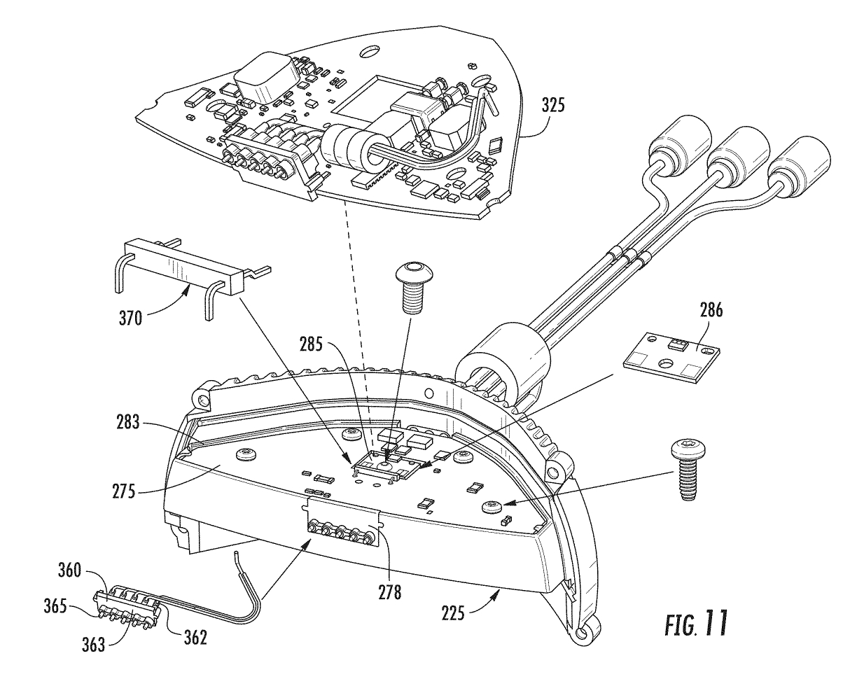

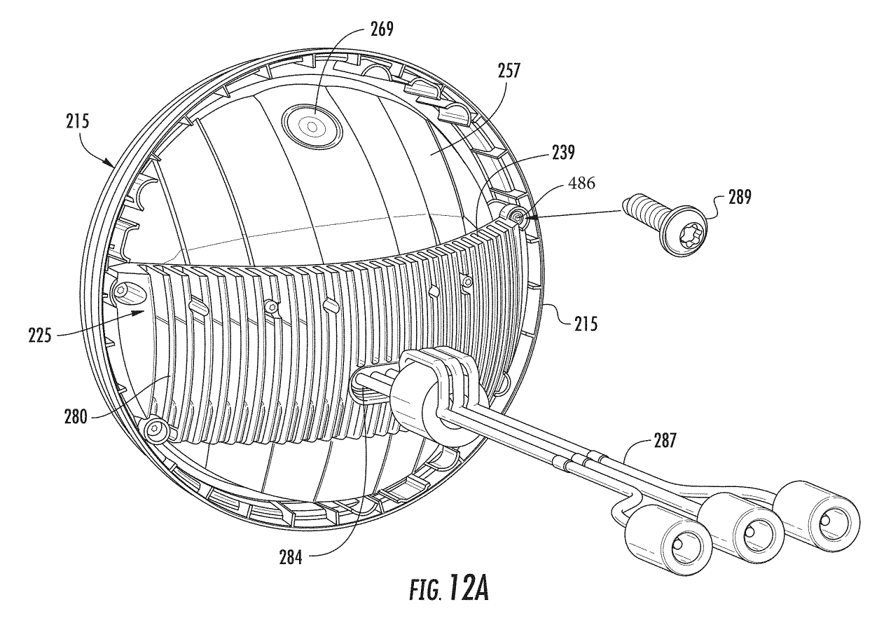

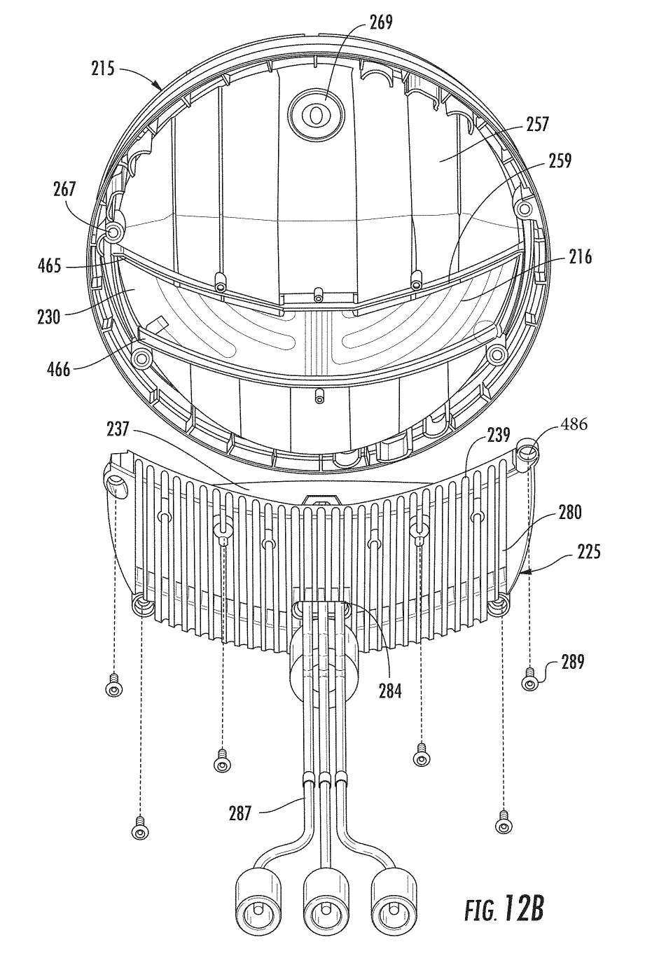

A front perspective view of heat sink structure 225 is shown in FIG. 9. Heat sink structure 225 includes planar segment 237 and external heat dissipating segment 239. Planar segment 237 includes a first side 273, a second side 275, and a lens adjacent edge 277, which extends through a slot formed in housing 215. Lens adjacent edge 277 is positioned in substantially the same plane as an annular rim of housing 215. A harness receiving portion 278 is formed within planar segment 237 at lens adjacent edge 277. Heat sink structure 225 also includes an external heat dissipating segment 239 positioned adjacent to the exterior surface of the housing and having a plurality of fins 280 formed therein.

Heat sink structure 225 is optimized to dissipate the largest amount of wattage as possible while using the least amount of material. The heat sink is made from a metal or thermally conductive plastic and allows for the alignment and assembly of the LEDs and the driver circuit board. In one embodiment, heat sink structure 225 is made from die cast aluminum through an injection molded process in a tool having slides that retract first to form the geometry around the LEDs and then eject normally in the direction of draw. Heat sink structure 225 allows for the alignment and assembly of the LEDs and the driver circuit board as well as for the heating element circuit board. A gasket groove 282 and alignment holes 486 for the assembly of the reflector/housing 215 are included.

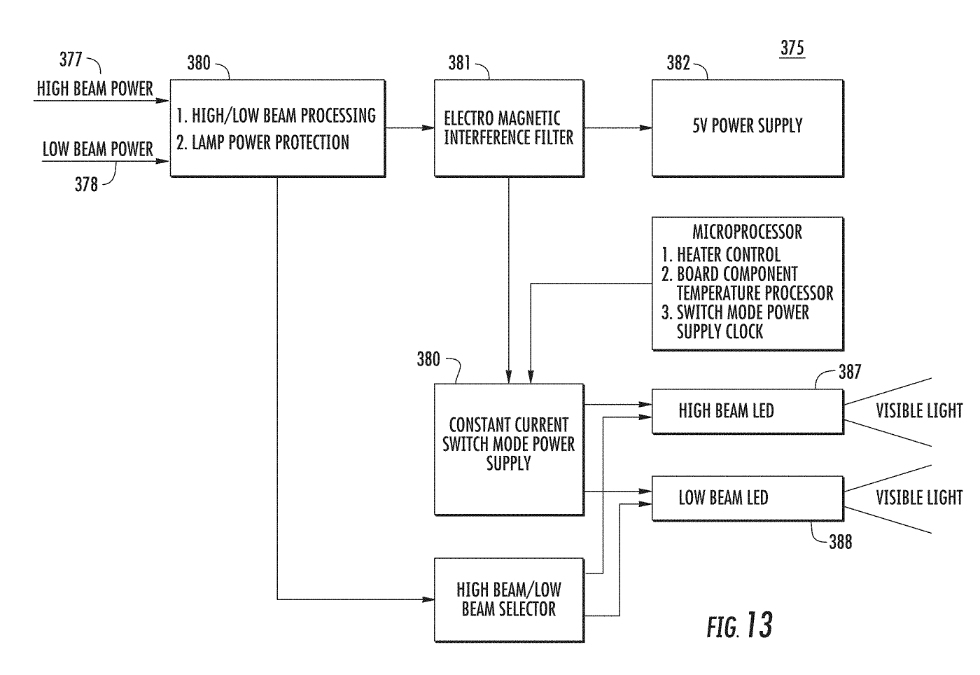

As illustrated in FIGS. 9 and 10, first side 273 includes a first light emitting diode receiving portion 255, which may take the form of an indented area sized to receive a light emitting diode assembly 265. Alignment posts, not shown, may be formed in first light emitting diode receiving portion 255 for aligning with datum features in a first light emitting diode assembly 265 for accurately aligning the light emitting diode assembly 265 on heat sink structure 225. In addition, first light emitting diode receiving portion 255 has holes formed therein for accepting fasteners, one of which is shown enlarged at 270, used for securing first light emitting diode assembly 265 to heat sink structure 225 in the same plane as first side 273 of planar segment 237. Light emitting diode assembly 265 also includes apertures 266 for receiving fasteners 270.

A combined buss bar and light blinder assembly 310 including a buss bar portion 311 and a light blinder portion 312 is shown enlarged in FIG. 10. Buss bar portion 311 includes thermal stampings that contact first light emitting diode assembly 265 at a first ends 315 and extend through an opening (not shown) formed in heat sink structure 225 to contact a circuit board positioned on a second side of heat sink planar segment 237 at second ends 316. Second ends 316 of buss bar portion 311 may be soldered to the circuit board 325 and first ends 315 of buss bar portion 311 may be soldered to first light emitting diode assembly 265. An overmold 327 is positioned over the thermal stampings to insulate thermal stampings from heat sink structure 225, which is formed of a conductive material. Overmold 327 may be formed of a material suitable for high temperature applications, such as a glass filled nylon material. As noted above, first ends 315 and second ends 317 are left uncovered to provide the necessary electrical contacts. In one embodiment, the thermal stampings are made of tin plated brass. Alternatively, a ribbon cable, buss bar, or other suitable device may be used to make an electrical connection.

Light blinder portion 312 may be connected to overmold 327 with an integral extension 330. Light blinder portion 312 is positioned on the first side of the planar segment 237 of the heat sink structure for blocking a section of light from the first light emitting diode assembly. In one embodiment, light blinder portion 312 blocks light from approximately (i.e. glare zone) in a photometric pattern. Light blinder portion 312 may include bottom projections 333 for contacting first light emitting diode assembly 265. Therefore, light blinder portion 312 is positioned perpendicular to first light emitting diode assembly 265 as shown in FIG. 10 such that light emitted in the 10 U to 90 U range is shielded.

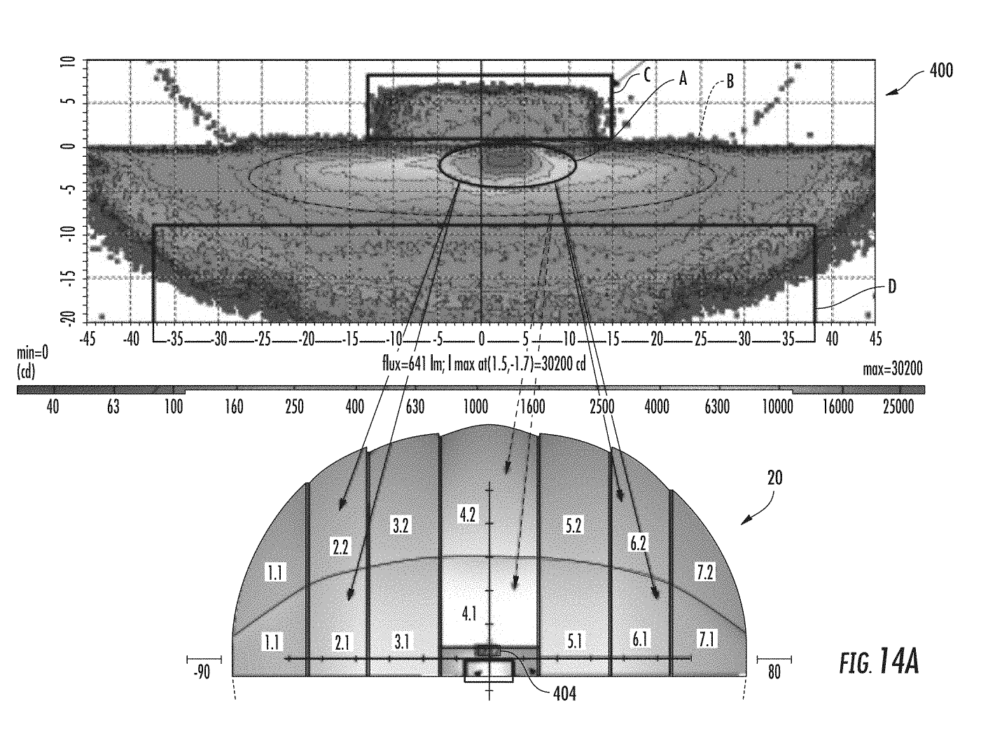

As shown in FIG. 11, second side 275 of heat sink structure 225 includes a second light emitting diode receiving portion 285 for aligning with a second light emitting diode assembly 286. A circuit board 325 is adapted to be positioned on second side 275 of heat sink structure 225. A BUSS bar 370 is provided for providing contact between second light emitting diode assembly 286 and circuit board 325.

A harness 360 with universal terminations on either end is used to connect heating element circuit board 240 to headlamp circuit board 325. Harness 360 attaches to circuit board 325 as shown in FIG. 11B and fits within a harness receiving opening or portion 278 of heat sink structure 225. Termination 362 of harness 360 at the main circuit board end will allow for bi-directional attachment to the main circuit board. The lens side termination 363 of the harness 360 includes pins 365 for connecting to leads of heating element circuit board 240. Specifically, ends of spring pins 365 contact gold plated pads on heating element circuit board 240. Spring pins 365 may be spring loaded with a maximum stroke of 0.090 inches. The spring applies a force to keep the terminals contacting the pads on circuit board 240, thereby allowing for a compliant connection. Spring pins 365 account for thermal expansion, movement due to vibration and/or shock, as well as tolerance stack-up of the assembly. During assembly, spring pins 365 are installed in an injection molding tool, prior to overmolding material being injected into the cavity. The material (PBT Valox) is injected into the core/cavity of the injection molding tool and completely surrounds the outside body of spring pins to form a rigid body/structure around the pins.

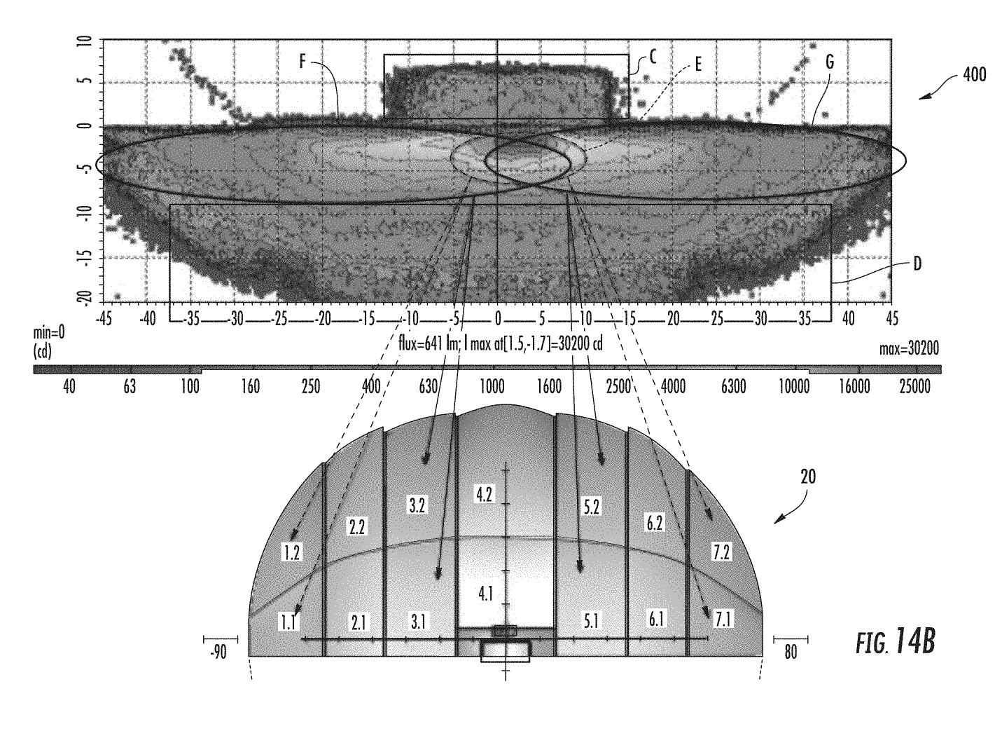

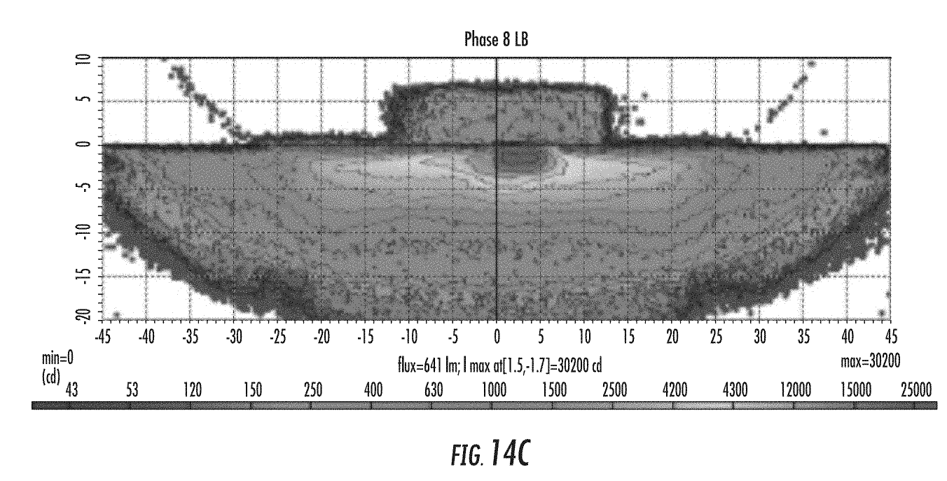

As illustrated in FIGS. 12A and 12B, housing 215 includes a Gore-Tex patch is placed within an opening 269 in housing 215 to prevent water from entering headlamp assembly 210 while allowing water vapor to escape. Housing 215 serves to provide environmental protection for first and second light emitting diode assemblies, 265 and 290, circuit board 325, and any wiring components. Housing 215 also provides a mounting interface for attaching headlamp assembly 210 to a vehicle.

As shown in FIG. 12B, heat sink structure 225 includes planar segment 237 and external heat dissipating segment 239. Planar segment 237 extends through slot 259 into housing 15. Lens 230 having heating element 216 is also shown in FIG. 12B. When headlamp assembly 210 is in an assembled configuration, external heat dissipating segment 239 is positioned adjacent to back side 257 of housing 215. External heat dissipating segment 239 includes a plurality of fins 280 formed therein. Heat sink structure 225 is optimized to dissipate the largest amount of wattage as possible while using the least amount of material. Material useful for forming heat sink structure 225 includes A360 aluminum. In one embodiment, heat sink structure 225 is made from die cast aluminum through an injection molded process in a tool having slides that retract first to form the geometry around the LEDs and then eject normally in the direction of draw. In general, heat sink structure 225 allows for the alignment and assembly of the LEDs and the driver circuit board within headlamp assembly 210. A power wire opening 284 for providing a passage for power wires 287 is formed in heat sink structure 225. Further, alignment holes 486 are provided for aligning with hoes 267 and receiving fasteners 289 for the assembly of the housing 215. The rear of the first reflector section 220 has a rib 465 that engages upper groove 282 and second reflector section 221 includes a rib 466 that engages lower groove 283, thereby creating a permanent weather tight seal.

As discussed above, headlamp assembly 210 emits both a high beam and a low beam. The low beam function uses only first reflector portion and first light emitting diode assembly. The high beam function uses both first and second reflector portion and both first and second light emitting diode assemblies.

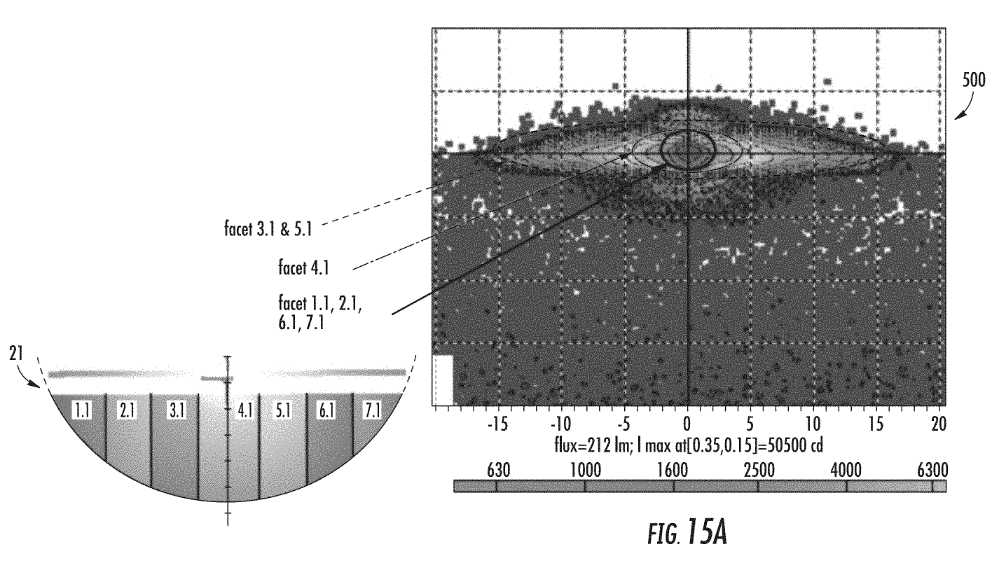

FIG. 13 is a block diagram of an exemplary driver circuit for use with headlamp assembly 10. Proper functioning of LEDs requires a constant current output. Thus, current regulators may be necessary to convert power originating from a vehicle battery. In addition, LEDs must be protected from transient voltages. As illustrated in FIG. 13, circuit 375 includes two power inputs (high beam and low beam) with each feeding power to a main power node 380. The electronic circuit senses when the high and low beam functions are powered. The lamp power protection is sensed by the microprocessor to verify the lamp is operating within its limits and only then it is allowed to operate. An electromagnetic interference filter is provided at 381 and a 5V power supply is shown at 382. Electromagnetic interference filter 381 prevents electrical noise from entering or leaving the lamp connected to external power and prevents the lamp from radiating radio frequency noise to the environment, as well as preventing the lamp from improper operation due to external radio interference. The main power node will feed the switch mode power supply 385 (SEPIC topology) creating a regulated output current for the single string of LEDs at the output. SEPIC topology is an electronic method of providing current to the LED's to illuminate them. The SEPIC provides current at a voltage, which can be higher or lower than the LED forward voltage. One of the LEDs in the string will be a high beam LED 387 and one will be a low beam LED 388. There will be a parallel MOSFET with this high beam LED. When only the low beam input is powered, the parallel MOSFET will be engaged to short out the high beam LED, leaving only the low beam LED to operate. When the high beam input is powered (regardless of whether the low beam input has power or not), the parallel MOSFET will be disengaged allowing current to flow in the entire LED string. There will be a circuit connecting a heater wire in the lens to the main power node for lens de-icing functions. There will also be a microcontroller in the circuit with the following functions: monitoring input voltage to set the LED current based on the input voltage and determine if the lamp is installed in a 12V or 24V application; monitoring the lamp temperature to set the LED current to prevent lamp damage if overheating occurs; monitoring the high beam input to determine if the parallel MOSFET needs to be either engaged or disengaged; monitoring ambient temperature to determine if the lens heater circuit needs to be engaged; monitor heater wire current to determine if heater is operating correctly and modulating power as necessary; and configuring the heater wire based on input voltage monitoring (decide 12V application or 24V application). There will also be circuitry to prevent damage or interference to the lamp from outside noise sources and to prevent the lamp from interfering with other modules, as shown at 380 in FIG. 13 at #2: lamp power protection. There will also be circuits to rapidly enable and disable the switch mode power supply based on the inputs to allow the lamp to be used in applications with Pulse Width Modulation.

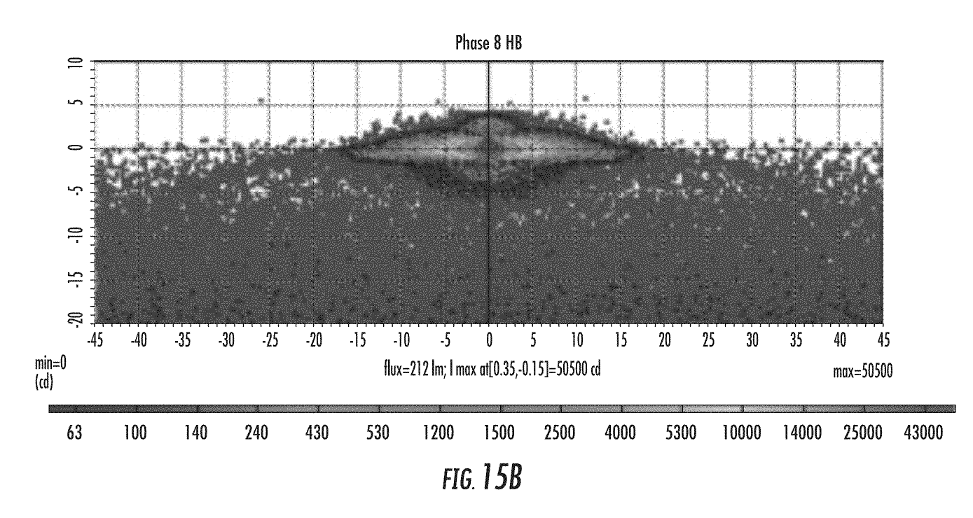

FIGS. 14A-16 are beam pattern intensity level plots provided to illustrate beam shape, vertical and horizontal spreads. FIGS. 14A and 14B illustrate light distribution patterns generated by specific facets of first reflector section 20 and FIG. 14C is the overall beam distribution pattern generated by first reflector section 20. The light intensity is shown in candelas as indicated in the key showing min=0 and max=30200. As shown in FIG. 14A, facets 2.1, 2.2, 6.1 and 6.2 contribute to area A of light distribution pattern 400. Area A is considered a hot zone. Facets 4.1 and 4.2 contribute to area B of light distribution pattern 400. Further, Light distribution pattern 400 has a sharp horizontal cutoff line parallel to and below a horizon. Facet 404 of first reflector section 20 forms a sign lighting area C of light distribution pattern 400. Area D of the beam pattern corresponds to a metalized blocker that is used to stop or block direct light from the LED into the scatter area of the beam pattern at 10 U, 90 U, 90 L/R. By metalizing the surface facing the LED, light is reflected back into the low beam reflector, thereby directing the light into the foreground area. As shown in FIG. 14A, the luminous flux (lm) is 641 lm, the maximum luminous intensity l_{Max} is shown at 1.5 and −1.7 and is 30200 candelas (cd). The luminous intensity distribution is from 0-30200 cd.

As shown in FIG. 14B, facets 1.1, 1.2, 7.1 and 7.2 contribute to area E of light distribution pattern 400. Further, facets 3.1 and 3.2 lead to area F and facets 5.1 and 5.2 lead to area G of light distribution pattern 400. As shown in FIG. 14B, the luminous flux (lm) is 641 lm, the maximum luminous intensity l_{Max} is shown at 1.5 and −1.7 and is 30200 candelas (cd). The luminous intensity distribution is from 0-30200 cd. The overall beam pattern that results from first reflector section 20 is illustrated in FIG. 14C. As shown in FIG. 14C, the overall low beam pattern has a luminous flux (lm) of 641 lm, the maximum luminous intensity l_{Max} is shown at 1.5 and −1.7 and is 30200 candelas (cd). The luminous intensity distribution is from 0-30200 cd.

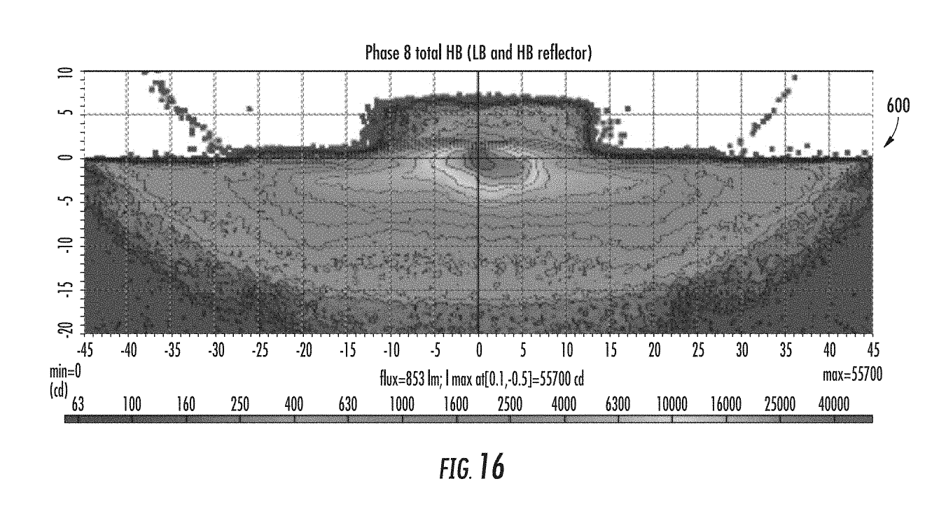

FIG. 15A is an illustration of a beam pattern 500 that results from second reflector section 21. Facets 1.1, 2.1, 6.1, and 7.1 contribute to area A′ of beam pattern 500. Further, facet 4.1 leads to area B′ and facets 3.1 and 5.1 result in area C′ of beam pattern 500. The overall beam pattern formed by second reflector section 21 is illustrated in FIG. 15B. The high beam pattern has a luminous flux (lm) of 212 lm, the maximum luminous intensity l_{Max} is shown at 0.35 and −0.15 and is 50500 candelas (cd). The luminous intensity distribution is from 0-50500 cd.

The overall beam pattern 600 for the headlamp assembly resulting from first and second reflector sections 20 and 21 is shown in FIG. 16. The overall beam pattern extends from 45 degrees from left to 45 degrees right and from 0 degrees to −20 degrees. As shown in FIG. 16, the luminous flux (lm) is 853 lm, the maximum luminous intensity l_{Max} is shown at 0.1 and -0.5 and is 55700 candelas (cd). The luminous intensity distribution is from 0-55700 cd. In one embodiment, the software utilized to create the disclosed macro focal free form reflector (LucidShape.™.) is manufactured by Brandenburg gmbh. As discussed above, a macro focal free form reflector design enables the focal point of the reflector to move about the emitter surface by virtue of multiple sets of focal points rather than one fixed focal point characteristic of conventional reflectors. Thus, the more complex the reflector's surface is, the more complex is the resultant beam pattern.

While description has been made in connection with embodiments and examples of the present invention, those skilled in the art will understand that various changes and modification may be made therein without departing from the present invention. It is aimed, therefore to cover in the appended claims all such changes and modifications falling within the true spirit and scope of the present invention.

We claim:

1. A headlamp assembly for a vehicle for emitting a high beam and a low beam, said headlamp comprising:
a unitary housing having an inner reflective surface having first and second reflector sections, an exterior surface, an annular rim and a slot formed therein;
a heat sink structure having a planar segment and an external heat dissipating segment, said planar segment having a first side, a second side, and a lens adjacent edge extending through the slot into the unitary housing and positioned in substantially the same plane as the annular rim, and said external heat dissipating segment abutting the exterior surface of the housing and having a plurality of fins formed therein;
a first light emitting diode assembly coupled to the first side of the planar segment of the heat sink structure;
a second light emitting diode assembly coupled to the second side of the planar segment of the heat sink structure; and
a lens bonded to the housing.

2. The headlamp assembly of claim 1, wherein a circuit board is positioned on the planar segment of the heat sink structure.

3. The headlamp assembly of claim 1, wherein the first light emitting diode assembly is positioned such that the optical axis of the first light emitting diode assembly is perpendicular to the first side of the planar section of the heat sink structure and the second light emitting diode assembly is positioned such that the optical axis of the second light emitting diode assembly is perpendicular to the second side of the planar section of the heat sink structure.

4. The headlamp assembly of claim 1, wherein illumination of the first light emitting diode assembly results in a low beam, and wherein illumination of both the first light emitting diode assembly and the second light emitting diode assembly results in a high beam.

5. The headlamp assembly of claim 1, further comprising a light blinder positioned on the first side of the planar segment for blocking a section of light from the first light emitting diode assembly.

6. The headlamp assembly of claim 5, wherein the light blinder blocks light from 10° U to 90° U in photometric pattern.

7. The headlamp assembly of claim 6, wherein light blinder is coupled to a BUSS bar.

8. The headlamp assembly of claim 1 wherein the lens is made from optically clear plastic and coated with a hard coat material that aids against environmental degradation.

9. The headlamp assembly of claim 8 wherein the lens includes heating elements attached to and embedded within an inner surface thereof to eliminate snow and ice, said inner surface also including an organosilicon coating to insulate the heating elements.

10. The headlamp assembly of claim 1 wherein the lens is vibration welded onto the annular rim of the housing.

11. A headlamp assembly for a vehicle for emitting a high beam and a low beam, said headlamp comprising:
a unitary housing having an inner reflective surface having first and second reflector sections, an exterior surface, an annular rim and a slot formed therein;
a heat sink structure having a planar segment and an external heat dissipating segment, said planar segment having a first side, a second side, and a lens adjacent edge extending through the slot into the unitary housing and positioned in substantially the same plane as the annular rim, and said external heat dissipating segment abutting the exterior surface of the housing and having a plurality of fins formed therein;
a first light emitting diode assembly coupled to the first side of the planar section of the heat sink structure;
a second light emitting diode assembly coupled to the second side of the planar section of the heat sink structure; and
a lens bonded to the housing; and
heating elements attached to and embedded within an inner surface of the lens to eliminate snow and ice, said inner surface also including coating to insulate the heating elements.

12. The headlamp assembly of claim 11, wherein a circuit board is positioned on the planar section of the heat sink structure.

13. The headlamp assembly of claim 11, wherein the first light emitting diode assembly is positioned such that the optical axis of the first light emitting diode assembly is perpendicular to the first side of the planar section of the heat sink structure and the second light emitting diode assembly is positioned such that the optical axis of the second light emitting diode assembly is perpendicular to the second side of the planar section of the heat sink structure.

14. The headlamp assembly of claim 11, wherein illumination of the first light emitting diode assembly results in a low beam, and wherein illumination of both the first light emitting diode assembly and the second light emitting diode assembly results in a high beam.

15. The headlamp assembly of claim 11, further comprising a light blinder positioned on the first side of the planar segment of the heat sink structure for blocking a section of light from the first light emitting diode assembly.

16. The headlamp assembly of claim 15, wherein the light blinder blocks light from 10° U to 90° U in photometric pattern.

17. The headlamp assembly of claim 16, wherein light blinder is coupled to a BUSS bar.

18. The headlamp assembly of claim 11 wherein the lens is made from optically clear plastic and coated with a hard coat material that aids against environmental degradation.

19. The headlamp assembly of claim 18 wherein the lens includes heating elements attached to and embedded within an inner surface thereof to eliminate snow and ice, said inner surface also including an organosilicon coating to insulate the heating elements.

20. The headlamp assembly of claim 11 wherein the lens is vibration welded onto the annular rim of the housing.
